(19) United States
(12) Patent Application Publication
(10) Pub. No.: US 2003/0011323 A1
(43) Pub. Date: Jan. 16, 2003

(54) Electrodeless bulb having surface adapted to enhance cooling

(76) Inventors: Douglas A. Kirkpatrick, Great Falls, VA (US); Anatoliy Y. Elbert, Baltimore, MD (US); Thomas L. Sumner, Wheaton, MD (US); Paul E. Steiner, Olney, MD (US)

Correspondence Address: FUSION LIGHTING INC, PAUL E STEINER, 7524 STANDISH PLACE, ROCKVILLE, MD, 20855

(21) Appl. No.: 10/170,402

(22) Filed: Jun. 14, 2002

Related U.S. Application Data
(60) Provisional application No. 60/301,481, filed on Jun. 29, 2001.

(51) Int. Cl. H05B 41/16

(52) U.S. Cl. 315/248

(57) ABSTRACT

An electrodeless discharge lamp includes an electrodeless lamp bulb enclosing a fill which emits light when excited, an excitation structure positioned near the bulb and adapted to excite the fill, a rotation assembly connected to the bulb and adapted to rotate the bulb during operation of the lamp, and a plurality of structures formed on an outer surface of the bulb adapted to enhance cooling of the bulb. In some cases the structures are distributed in accordance with a temperature profile of the bulb to provide a relatively more uniform bulb temperature during operation. Some structures include protrusions which are distributed around the entire surface of the bulb. Some structures include protrusions which are distributed around the entire surface of the bulb except in the region of the bulb equator. Some structures include a plurality of ribs attached to an outer surface of the bulb, wherein the ribs are aligned transverse to a plane of the equator of the bulb. In some cases the ribs are offset from the surface of the bulb by one or more supports. Some structures include a pair of rings attached to an outer surface of the bulb.

### CROSS-REFERENCE TO RELATED APPLICATIONS

This application is based on and claims the benefit of priority from U.S. Provisional Patent Application No. 60/301,481, filed Jun. 29, 2001.

Certain inventions described herein were made with Government support under Contract No. DE-FC26-00NT40988 awarded by the Department of Energy. The Government has certain rights in those inventions.

### BACKGROUND

1. Field of the Invention

The invention relates generally to electrodeless discharge lamps and more specifically to novel electrodeless bulb structures which enhance bulb cooling.

2. Related Art

Electrodeless lamps with rotating bulbs are known in the art. U.S. Pat. No. 4,485,332 discloses a microwave discharge lamp in which the bulb is rotated to improve cooling. U.S. Pat. No. 5,825,132 discloses a capacitively coupled electrodeless lamp with a rotation subsystem. In addition to cooling benefits, many lamps fills also benefit from rotation of the bulb to promote a stable discharge and increase light output. U.S. Pat. No. 5,977,724 describes the benefits of rotating small bulbs fast enough to eliminate partial discharges.

Most bulbs which are rotated are spherical. However, bulbs of a wide variety of shapes are known. U.S. Pat. No. 6,181,054 discloses a variety of bulbs having two or more piece construction with a variety of shapes other than spherical. Japanese Patent Publication No. 10-069890 discloses a bulb having an ellipsoidal shape which is rotated at varying rates to change the effective length of the arc discharge.

Some conventional high power lamps use forced air cooling to maintain the bulb at a suitable operating temperature during operation. Various structures have been proposed to promote bulb cooling. The aforementioned '054 patents describes a bulb with an integral heat sink element. A plurality of fins or outwardly projecting stubs increase the outside surface area of the bulb, thereby enhancing heat dissipation from the bulb. Japanese Patent Publication No. 10-149803 describes a bulb with a thickened wall section to improve temperature uniformity around the bulb. Also disclosed is a spherical bulb with either fins or ridges formed around the equator region of the bulb. The fins or ridges increase the outside surface area of the bulb, thereby enhancing heat dissipation from the bulb.

Other structures have been proposed which take advantage of the rotation of the bulb to circulate air around the bulb. U.S. Pat. No. 5,614,780 describes various structures such as fins or fan blades on the bulb support rod. U.S. Statutory Invention Registration No. H1,876 describes various structures on the bulb itself such as fins or fan blades.

### SUMMARY

The following and other objects, aspects, advantages, and/or features of the invention described herein are achieved individually and in combination. The invention should not be construed as requiring two or more of such features unless expressly recited in a particular claim.

One aspect of the invention is to provide novel structures on the surface of an electrodeless bulb which increase the surface area of the bulb to promote cooling. Another aspect of the invention is to provide novel structures on the surface of the bulb which tend to break up a boundary layer of air around the bulb when rotated.

Some aspects of the invention are achieved by a discharge lamp which includes an electrodeless lamp bulb enclosing a fill which emits light when excited; an excitation structure positioned near the bulb and adapted to excite the fill; a rotation assembly connected to the bulb and adapted to rotate the bulb during operation of the lamp; and a plurality of protrusions formed on an outer surface of the bulb and distributed around the entire bulb surface.

In some examples, no protrusions are provided around the bulb equator. The protrusions are preferably relatively small (e.g. less than 15% of the bulb diameter). In some examples, the protrusions are formed as ribs which are aligned transverse to the equator. For example, the ribs may run along lines of longitude with respect to the bulb equator. In other examples the ribs are raised from the surface of the bulb by one or more supports.

According to another aspect of the invention, the protrusions are distributed in accordance with a temperature profile of the bulb in its intended operating environment to provide a more uniform operating temperature. For example, relatively more protrusions are concentrated near the hot spot of the bulb to promote relatively more cooling of that area.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a perspective view of a conventional electrodeless bulb for use in a microwave discharge lamp.

FIG. 2 is a perspective view of a first example of an electrodeless bulb according to the present invention having a surface adapted to enhance cooling.

FIG. 3 is a perspective view of a second example of a bulb of the present invention.

FIG. 4 is a perspective view of a third example of a bulb of the present invention.

FIG. 5 is a perspective view of a fourth example of a bulb of the present invention.

FIG. 6 is a perspective view of a fifth example of a bulb of the present invention.

FIG. 7 is a schematic view of a sixth example of a bulb of the present invention.

FIG. 8 is a schematic view of a seventh example of a bulb of the present invention.

FIG. 9 is a perspective view of an eighth example of a bulb of the present invention.

FIG. 10 is a perspective view of a ninth example of a bulb of the present invention.

FIG. 11 is a perspective view of a tenth example of a bulb of the present invention.

FIG. 12 is a front schematic view of an eleventh example of a bulb of the present invention.

FIG. 13 is a side schematic view of the eleventh example.

FIG. 14 is a front schematic view of a twelfth example of a bulb of the present invention.

FIG. 15 is a side schematic view of the twelfth example.

FIG. 16 is a perspective view of a thirteenth example of a bulb of the present invention.

FIG. 17 is a perspective view of a standard bulb showing an example of a temperature profile.

FIG. 18 is a perspective view of a fourteenth example of a bulb of the present invention.

FIG. 19 is a schematic diagram of a lamp system suitable for utilizing the bulbs of the present invention.

FIG. 20 is a schematic diagram of a temperature measurement system for evaluating the bulbs of the present invention.

FIG. 21 is a chart of bulb temperature comparing bulbs of the present invention with standard spherical bulbs.

FIG. 22 is a graph of bulb temperature versus rotation speed comparing bulbs of the present invention with standard spherical bulbs.

### DESCRIPTION

In the following description, for purposes of explanation and not limitation, specific details are set forth such as particular structures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

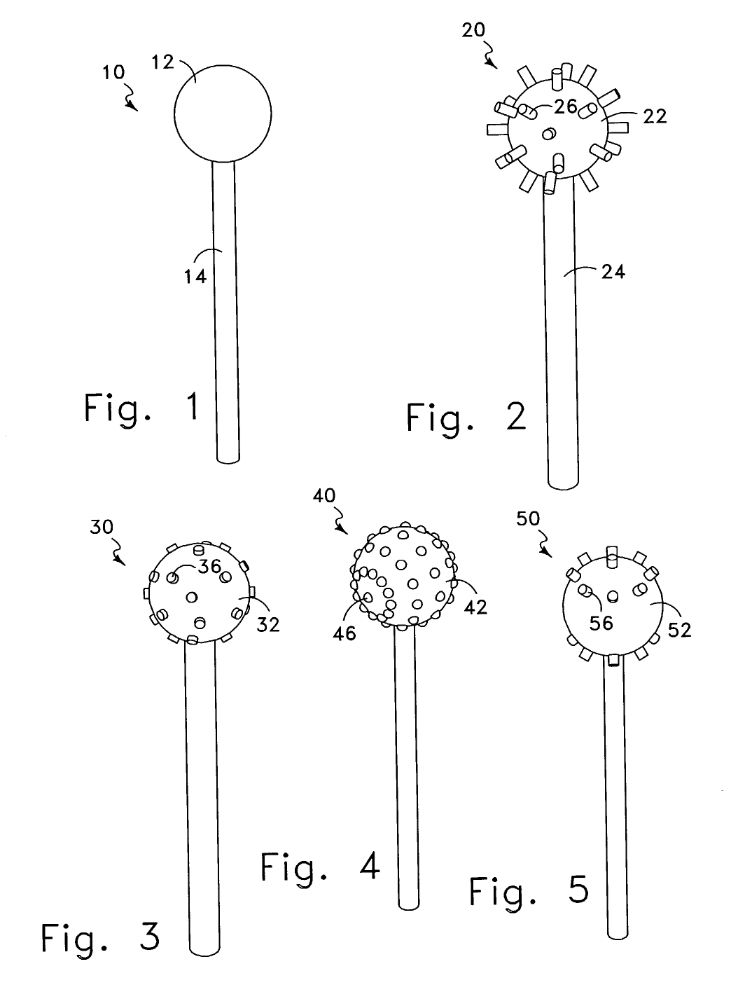

With reference to FIG. 1, a standard electrodeless bulb 10 for use in a microwave discharge lamp includes a sealed, light transmissive envelope 12 mounted on a stem 14. Typically, both the envelope 12 and the stem 14 are made from quartz. The envelope 12 is a hollow sphere typically on the order of between 20 mm and 40 mm outer diameter (OD) with a wall thickness in the range of 0.5 mm to 2 mm (usually 1 mm), although larger or smaller envelope sizes and wall thicknesses are possible. The stem 14 may be hollow or solid.

The stem 14 may be secured to a motor for rotation of the bulb during operation. The envelope 12 encloses fill materials which emit light when excited by microwave energy. For example, the fill may include a rare gas and sulfur, selenium, or tellurium. Other fill materials include metal halides such as indium halide, tin halide, or sodium halides. Numerous mercury based fills may also be used. The invention is not fill dependent. During operation, heat is conducted from the walls of the envelope 12. When the bulb is rotated, a boundary layer of air forms around the envelope 12 which acts as insulation and limits the amount of heat which can be shed.

With reference to FIG. 2, an electrodeless bulb 20 includes an envelope 22 mounted on a stem 24. A plurality of protrusions 26 are disposed around the entire outer surface of the envelope 22. For example, the protrusions 26 may be made from short sections of quartz rod (e.g. 3 mm protrusions on a 30 mm OD envelope) which are welded to the outer surface of the envelope 22. The protrusions 26 effectively increase the outer surface area of the bulb 20, thereby enhancing cooling of the bulb 20 during operation. When the bulb 20 is rotated, the protrusions 26 also break up the boundary layer of air around the envelope 22, thereby further increasing the amount of heat which can be shed from the bulb 20.

With reference to FIGS. 3-5, alternative structures include a bulb 30 with even shorter protrusions 36 (e.g. 1 mm) on the envelope 32. A bulb 40 has a plurality of bumps 46 on the envelope 42. Such bumps 46 may be easier to manufacture as part of a mold for the bulb 40. A bulb 50 has medium size protrusions 56 (e.g. 2 mm) on the envelope 52 with no protrusions in the region of the equator of the envelope 52. As used herein, an analogy is made between the rotation of the bulb and the rotation of the earth. The axis of the rotation of the bulb corresponds to the lengthwise axis of the stem. The position where the stem is attached to the envelope corresponds to the south pole. The opposite position corresponds to the north pole. And the circular plane which bisects those two positions perpendicular to the axis of rotation corresponds to the equator.

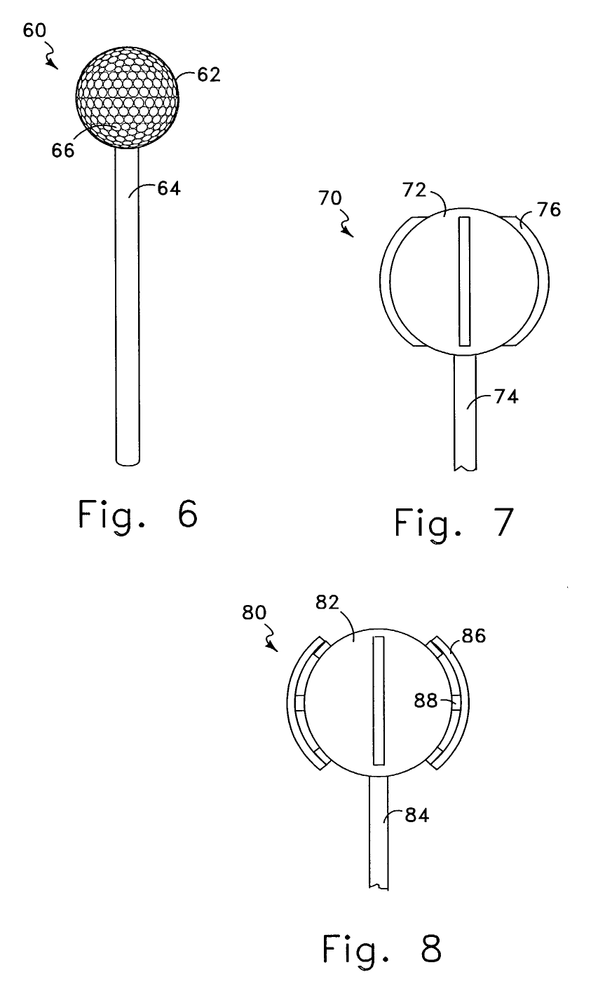

FIG. 6 illustrates a bulb 60 including an envelope 62 mounted on a stem 64. A plurality of dimples 66 are formed in the surface of the envelope 62, similar in appearance to a golf ball. In this examples, the dimples 66 have the opposite effect of the previously described protrusions with respect to the boundary layer of air. The dimples 66 tend to promote the formation of a boundary layer of air during rotation and thereby increase the insulation and heating of the bulb. Such dimples may be useful at lower power ranges or in other applications where the bulb temperature is too low. Although the bulb 60 is illustrated as having the entire surface 62 with dimples, fewer dimples may be distributed around the surface as may be necessary or desirable. Numerous dimple patterns may useful for creating different air flow patterns around the bulb.

With reference to FIG. 7, an electrodeless bulb 70 includes an envelope 72 mounted on a stem 74. A plurality of ribs 76 are disposed on the outer surface of the envelope 72. The ribs 76 increase the surface area of the bulb, thereby promoting cooling. Preferably, the ribs 76 are positioned transverse to the equator of the envelope 72 so that during operation the ribs 76 break up the boundary layer of air around the envelope 72 and further enhance cooling. For example, the ribs 76 as illustrated are perpendicular to the equator, running with lines of longitude of the envelope 72. If the ribs 76 were parallel to the equator (e.g. running with lines of latitude), they would increase the surface area, but they would have less of an effect on the boundary layer of air. For example, the ribs 76 are made from 1.5 mm diameter quartz rods which are bent and welded to the outer surface of the envelope 72.

With reference to FIG. 8, an electrodeless bulb 80 includes an envelope 82 mounted on a stem 84. A plurality of raised ribs 86 are disposed on spacers 88 on the outer surface of the envelope 82. The spacers 88 and ribs 86 increase the surface area of the bulb, thereby promoting cooling. Preferably, the raised ribs 86 are positioned transverse to the equator of the envelope 82 so that during operation the raised ribs 86 break up the boundary layer of air around the envelope 82 and further enhance cooling. The raised ribs 86 and supports 88 create a turbulence pattern which is effective for breaking up the boundary layer.

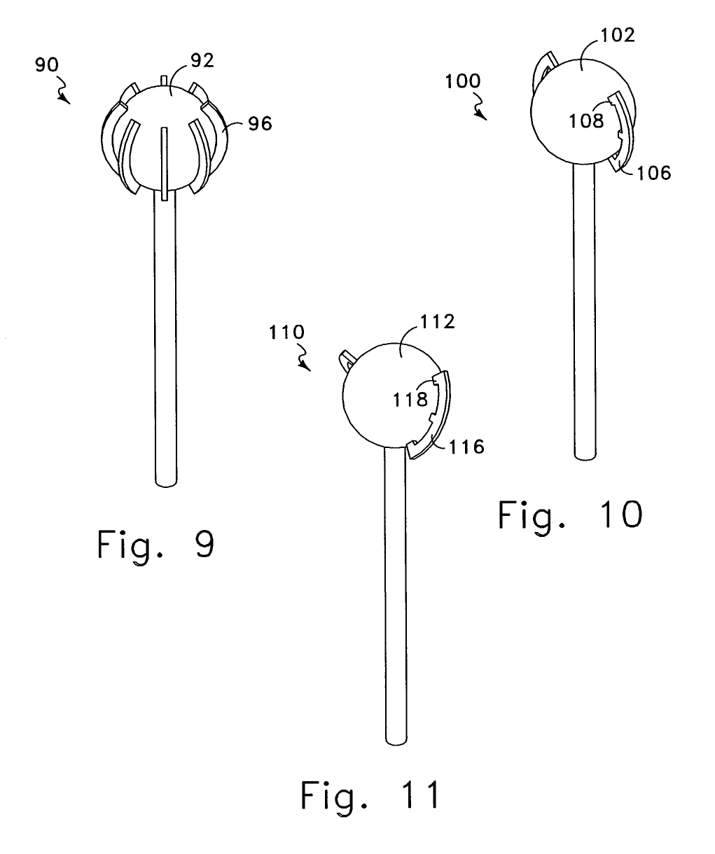

With reference to FIG. 9, a bulb 90 includes an envelope 92 with eight (8) longitudinal ribs 96.

With reference to FIG. 10, a bulb 100 includes an envelope 102 with two (2) longitudinal raised ribs 106 on supports 108. With reference to FIG. 11, a bulb 110 includes an envelope 112 with two raised ribs 116 arranged transverse but not orthogonal to the equator of the bulb 112. In this examples, the raised ribs 116 are rotated about 30° off of orthogonal.

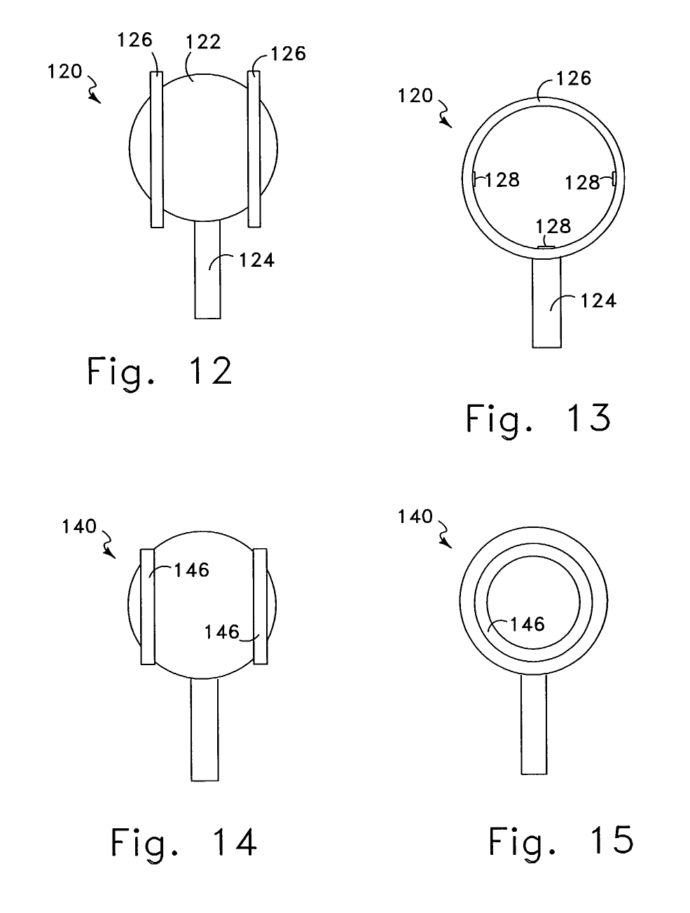

With reference to FIGS. 12-13, an electrodeless bulb 120 includes and envelope 122 mounted on a stem 124. A pair of rings 126 are disposed opposite of each other on the outer surface of the envelope 122. For example, the rings 126 are made from quartz. The rings 126 have an inside diameter which is less than the outside diameter of the envelope 122 and the rings are positioned against the outer surface of the envelope 122 and tacked down in several locations 128. The outer diameter of the rings 126 extends beyond the outer diameter of the envelope 122.

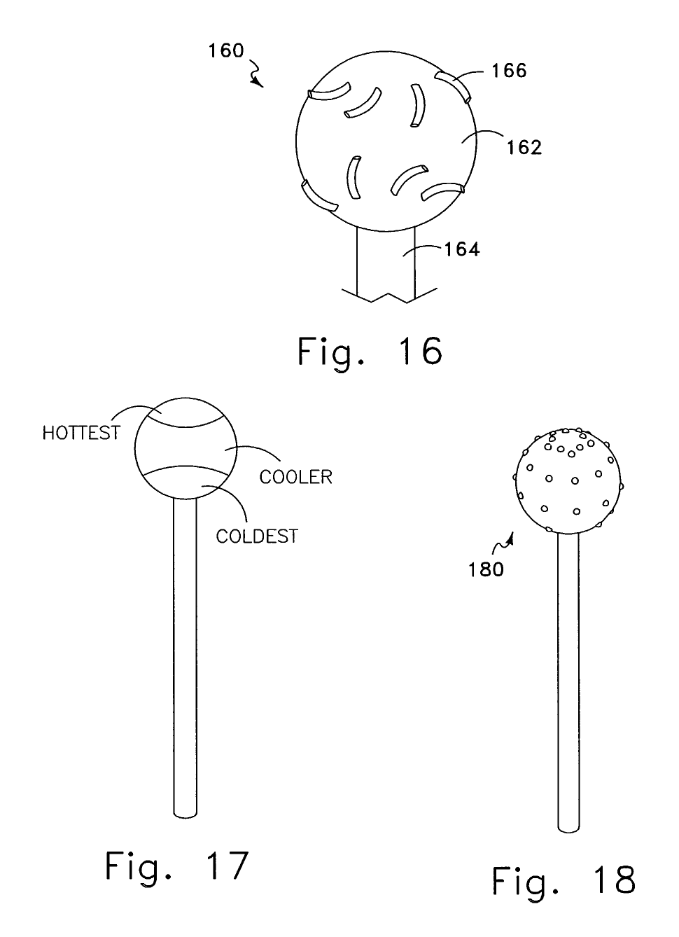

With reference to FIGS. 14-15, an electrodeless bulb 140 is similar to the bulb 120, except with smaller diameter rings 146.

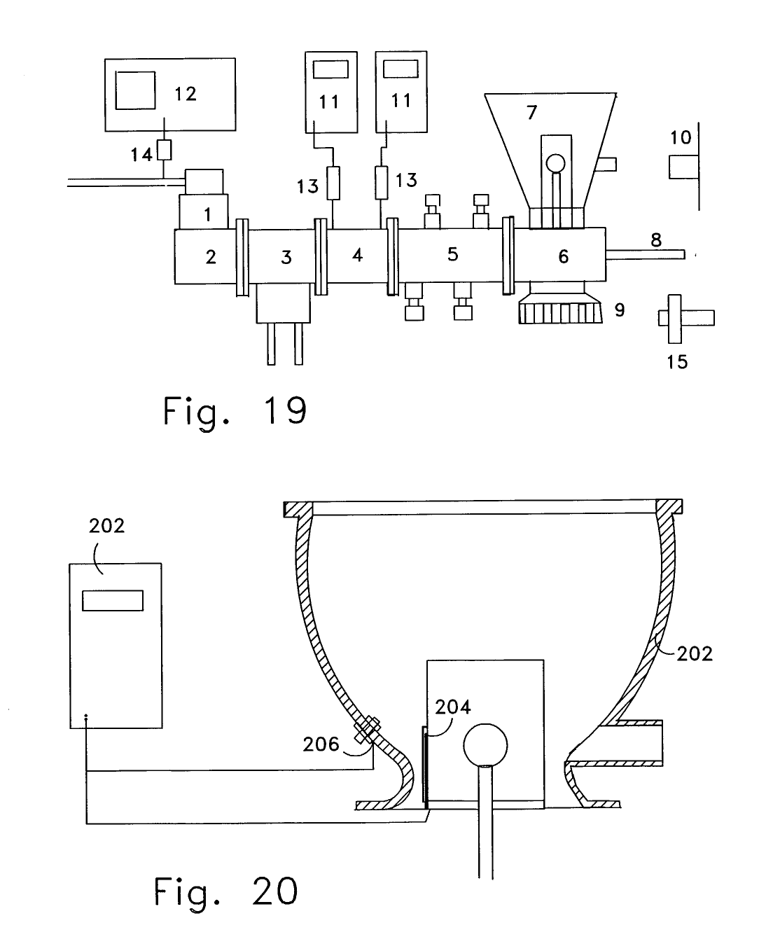

With reference to FIG. 16, an electrodeless bulb 160 includes an envelope 162 mounted on a stem 164. A plurality of curved ribs 166 are positioned near the poles of the envelope 162 to increase the surface area of the bulb 160 and to create a turbulence pattern which breaks up the boundary layer of air.

A uniform bulb temperature distribution is a desirable operating characteristic of an electrodeless lamp. Rotation of the bulb improves the uniformity. However, even with rotation the bulb has regions which are hotter and cooler. With reference to FIG. 17, a microwave discharge lamp may have a bulb which during operation in a vertical position has a hot spot near the top (because the hot plasma tends to float up), a cold spot near the bottom (because heat is conducted through the stem), and a temperature region in the middle which is between the two extremes.

According to a present aspect of the invention, the surface topology of the bulb is designed to take into account the temperature distribution of the bulb to provide a more even temperature distribution.

With reference to FIG. 18, a bulb 180 includes a greater concentration of protrusions at the top of the bulb (the hot spot), few or no protrusions at the bottom of the bulb (the cold spot), and a moderate number of protrusions around the middle of the bulb. The greater concentration of protrusions has a larger surface area and also causes a greater disturbance to the boundary layer of air, thereby providing a greater cooling effect at the top of the bulb. The absence of protrusions at the bottom allows the boundary layer to remain intact at the bottom of the bulb, thereby maintaining the insulation provided by the boundary area.

Other structures such as rods, dimples, fins, and/or ribs may be used to achieve the variable cooling effect and relatively more uniform bulb temperature during operation. Alternatively, in some lamps it is desirable to raise the cold spot temperature. The dimpled bulb surface as described in connection with FIG. 6 may be configured to provide varying concentrations of dimples to make the envelope temperature more uniform by increasing the insulation effect near the cold spot.

Test Results

For the purpose of comparing light output and operating temperature, nine 35 mm bulbs were prepared with the same fill but different surface topologies. Three of the nine bulbs were standard spherical bulbs, three had 30 protrusions arranged as shown in FIG. 2 (Example #1) and three had 24 protrusions with none on the equator as shown in FIG. 5 (Example #4). In each case, the protrusions were short pieces of a quartz tube with OD=3 mm, ID=1.6-1.8 mm and a length of 4-5.5 mm.

With reference to FIG. 19, the electrodeless microwave discharge apparatus used to conduct the comparison consists of the following devices and components:

1—magnetron 2M244 F7D 12080

2—waveguide

3—3 port circulator GL-401A, s/n 398 with short dummy load GL402A,s/n 342

4—dial directional coupler GL206, s/n 276

5—4-Stub-Tuner

6—waveguide with bulb and RF screen

7—reflector with temperature viewing port

8—adjustable wall of the waveguide

9—bulb rotation motor (with integral fan)

10—Inframetrics 760 s/n 8770 or IRCON Modline with T-2 lens, s/n 350521

11—Power meter HP 435B, s/n 2005AO1145 and 2342AO9322

12—Oscilloscope TDS460A, s/n B010298

13—Power sensor 8482A

14—High voltage probe/divider P6015, 1000×3 pF, 100 MΩ

15—Tachometer Cole-Parmer 8204-20

With reference to FIG. 20, the screen temperature and temperature on the surface of the reflector were measured with K-type thermocouples and a Fluke 51-T K/J thermometer (202 in FIG. 20). A copper foil and a copper braid were used to keep stray electromagnetic fields out of the thermocouple wire. The end of one thermocouple 204 was tightly connected to the narrow joint strip of the screen. Another thermocouple 206 was installed on the outside surface of the reflector and fastened with screw, washer and nut.

For the data in Table 1, the bulbs were rotated at 3000 RPM, the line voltage was 208 VAC, and the measured magnetron current was 3.9 KVDC.

TABLE 1

| | Example #1 | | | Example #4 | | | STANDARD | | |
|---|---|---|---|---|---|---|---|---|---|
| | reflector, no mirror | | | reflector, no mirror | | | reflector, no mirror | | |
| | no reflector, no mirror | | | no reflector, no mirror | | | no reflector, no mirror | | |
| Bulb # | 1 | 2 | 3 | 5 | 6 | 7 | 9 | 10 | 11 |
| Pline | 1404 | 1407 | 1404 | 1402 | 1406 | 1406 | 1407 | 1400 | 1404 |
| (W) | | 1408 | | | | 1405 | 1408 | | |
| Pfwd | 898 | 902 | 898 | 902 | 902 | 902 | 898 | 902 | 902 |
| (W rf) | | 902 | | | | 902 | 902 | | |
| Pref | 3.2 | 1.9 | 2.4 | 1.6 | 1.8 | 1.4 | 2.2 | 3.3 | 1.5 |
| (MR) | | 2.1 | | | | 1.8 | 2.0 | | |
| T (° C.) | 980 | 1006 | 980 | 987 | 1021 | 980 | 1125 | 1100 | 1133 |
| Ircon | | 870 | | | | 837 | 927 | | |
| T (° C.) | 1010 | 1042 | 1027 | 998 | 1041 | 1021 | 1113 | 1102 | 1138 |
| Inf. | | 906 | | | | 874 | 997 | | |
| Lux | 14920 | 14440 | 14630 | | 13660 | 14720 | 14620 | 14830 | 14730 |

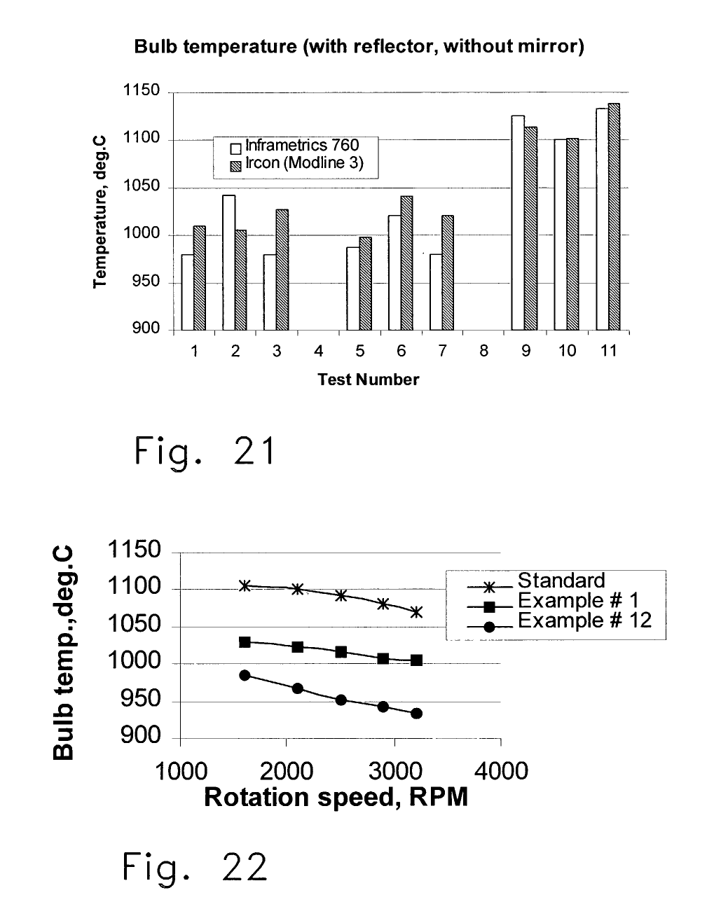

FIG. 21 is a chart of both bulb temperature readings for the Test Bulb #'s in Table 1. As is apparent from Table 1 and FIG. 21, the bulbs of the present invention have a temperature which is 80-100 degrees C. less during operation as compared to standard spherical bulbs. Moreover the cooler bulbs of the present invention provide comparable light output. Without being limited to theory of operation, it is believed that the structures on the surface of the bulbs of the present invention break up the boundary layer of air around the bulb and also increase the bulb surface area, thereby enhancing cooling of the bulb.

Another comparison was made between standard spherical bulbs and the bulbs of Examples #1, 4, 11, and 12. The lighting apparatus is as described above in connection with FIGS. 19-20.

The bulb for Example #11 has a 35 mm OD and has two rings with OD=37 mm connected to the bulb at three solder points with a small gap between the rings and the bulb. The gap between the ring and a surface of the ball excluding the 3 connection points is about 0.01-0.05 mm.

The bulb for Example #12 has a 35 mm OD and has two rings with OD=28 mm soldered to the bulb completely around the ring with no gap.

The speed of the bulb motor was changed with variable auto-transformer and measured with the tachometer.

TABLE 2

| | BULB TEMPERATURE (° C.) | | | | | | | | |
|---|---|---|---|---|---|---|---|---|---|
| Speed | Example # | | | | | | Standard | | |
| RPM | #1 | #2 | #3 | Ex. 4 | Ex. 11 | Ex. 12 | #1 | #2 | #3 |
| 1600 | 995 | 1036 | 992 | 1030 | 1058 | 985* | 1106 | 1120 | 1096 |
| 2100 | 985 | 1012 | 978 | 1022 | 1050 | 968* | 1101 | 1110 | 1087 |
| 2500 | 977 | 993 | 969 | 1015 | 1042 | 952 | 1091 | 1102 | 1077 |
| 2900 | 969 | 978 | 964 | 1008 | 1036 | 942 | 1080 | 1097 | 1064 |
| 3200 | 961 | 965 | 949 | 1004 | 1032 | 934 | 1070 | 1092 | 1056 |
| Reflector | 185 | 182 | 177 | 196 | 171 | 173 | 174 | 179 | 173 |
| Temp ° C. | | | | | | | | | |
| Screen | 386 | 360 | 356 | 391 | 387 | 343 | 407 | 405 | 416 |
| Temp ° C. | | | | | | | | | |
| Light | 14860 | 14730 | 15100 | 14520 | 14640 | 15430 | 15300 | 15100 | 15500 |
| output | | | | | | | | | |

*flicker observed

FIG. 21 is a comparison graph of bulb temperature versus rotation speed for Standard bulb #1, Example #1, and Example #12. As noted above, the bulbs of the present invention run cooler and have comparable light outputs as compared to standard spherical bulbs. The bulb temperature decreases 3-8 % when bulb rotation speed was changed from 1600 to 3200 RPM.

The bulbs of the present invention may be used in combination with other conventional cooling techniques (e.g. forced air, jets, fins on stem, fins on bulb) to further enhance cooling of the bulb during operation.

While the invention has been described in connection with what is presently considered to be the preferred examples, it is to be understood that the invention is not limited to the disclosed examples, but on the contrary, is intended to cover various modifications and equivalent arrangements included within the spirit and scope of the inventions.

What is claimed is:

1. A discharge lamp, comprising:
an electrodeless lamp bulb enclosing a fill which emits light when excited;
an excitation structure positioned near the bulb and adapted to excite the fill;
a rotation assembly connected to the bulb and adapted to rotate the bulb during operation of the lamp; and
a plurality of structures formed on an outer surface of the bulb, wherein the structures are distributed in accordance with a temperature profile of the bulb to provide a relatively more uniform bulb temperature during operation.

2. The discharge lamp of claim 1, where the structures comprise protrusions.

3. The discharge lamp of claim 1, wherein the structures comprise dimples.

4. A discharge lamp, comprising:
an electrodeless lamp bulb enclosing a fill which emits light when excited;
an excitation structure positioned near the bulb and adapted to excite the fill;
a rotation assembly connected to the bulb and adapted to rotate the bulb during operation of the lamp; and
a plurality of protrusions formed on an outer surface of the bulb, wherein the protrusions are distributed around the entire surface of the bulb.

5. A discharge lamp, comprising:
an electrodeless lamp bulb enclosing a fill which emits light when excited;
an excitation structure positioned near the bulb and adapted to excite the fill;
a rotation assembly connected to the bulb and adapted to rotate the bulb during operation of the lamp; and
a plurality of protrusions formed on an outer surface of the bulb, wherein the protrusions are distributed around the entire surface of the bulb except in the region of the bulb equator.

6. A discharge lamp, comprising:
an electrodeless lamp bulb enclosing a fill which emits light when excited;
an excitation structure positioned near the bulb and adapted to excite the fill;
a rotation assembly connected to the bulb and adapted to rotate the bulb during operation of the lamp; and
a plurality of ribs attached to an outer surface of the bulb, wherein the ribs are aligned transverse to a plane of the equator of the bulb.

7. The discharge lamp of claim 6, wherein the ribs are offset from the surface of the bulb by one or more supports.

8. A discharge lamp, comprising:
an electrodeless lamp bulb enclosing a fill which emits light when excited;
an excitation structure positioned near the bulb and adapted to excite the fill;
a rotation assembly connected to the bulb and adapted to rotate the bulb during operation of the lamp; and
a pair of rings attached to an outer surface of the bulb.
